(19) United States
(12) Patent Application Publication
(10) Pub. No.: US 2017/0151589 A1
(43) Pub. Date: Jun. 1, 2017

(54) A SYSTEM AND METHOD FOR CLEANING A BOILER

(71) Applicant: AV SOOTBLOWER AB, Skellefteå (SE)

(72) Inventor: Harry JOHANSSON, Skellefteå (SE)

(21) Appl. No.: 15/323,382

(22) PCT Filed: Jul. 3, 2015
(86) PCT No.: PCT/SE2015/050792

§ 371 Date: Dec. 30, 2016

(30) Foreign Application Priority Data
Jul. 3, 2014 (SE) 1450834-5

(51) Int. Cl. B08B 7/02; F28G 15/02; F28G 7/00

(52) U.S. Cl. CPC B08B 7/02; F28G 7/00; F28G 15/02

(57) ABSTRACT

The invention relates to a system (1) connectable to a boiler, the system comprising housing (2) connectable to the boiler defining a shock wave chamber (3). An electrically conducting wire (4) is provided in the shock wave chamber, and electrical means (5) are provided for generating an electrical discharge pulse through the wire such that to evaporate the wire. Thereby a shock wave for is generated for cleaning of dust deposit from surfaces in the boiler. Further to this, a method for cleaning a boiler is disclosed.

### TECHNICAL FIELD

The present invention relates generally to systems and methods for cleaning of dust deposits in boilers.

### BACKGROUND ART

In power plants, boilers and the like, dust and/or soot particles are deposited on the surfaces of the processing equipment. Such deposits reduce heat transfer in the system and increase pressure losses. Therefore it is needed to clean the boiler from such deposits.

Conventionally, cleaning of dust deposit from surfaces in a boiler, has been carried out by methods comprising the steps of blowing the equipment with air or steam. Steam blowing has the disadvantage that it sometimes hardens the deposit and causes erosion on the tube surfaces.

More recently, new technology has been developed in which soot-removal is effected by the use of sound. Conventional sound generators employed in such methods use pressure air or a rotating siren to make the sound, which is amplified in an expanded horn and directed towards the surfaces where cleaning is needed. The sound pressure, as given in decibels, is not necessarily the best indication for the cleaning power of the device. Sound is normally sinus-waved, and the lower the frequency the lower the rate of change from low pressure to high pressure.

Further to this, technology has been developed wherein pressure pulses are provided for cleaning of dust deposit in a boiler, by igniting a combustible gas mixture. Such a gas pulse cleaner is described in WO 01/78912 A1. Another example of an explosion pulse cleaners, wherein a bag filled with combustible gas is introduced into the boiler, is described in EP 1362213 A1.

However, the use of explosive gases or other fuel mixtures in a power plant environment may be undesired, because of risks of explosions.

### SUMMARY OF INVENTION

An object of the present invention is thus to provide a safer yet still effective system and method of cleaning of dust deposit from surfaces in a boiler.

Thus the invention relates to a system connectable to a boiler, the system comprising a housing connectable to the boiler defining a shock wave chamber. An electrically conducting wire is provided in the shock wave chamber, and electrical means are provided for generating an electrical discharge pulse through the wire such that to evaporate the wire. Thereby a shock wave is generated for cleaning of dust deposit from surfaces in the boiler. The generation of a shock wave by means of an electrically exploding wire is advantageous since it effectively generates a shock wave, and without the presence of any combustible fuel or gas.

The system may comprise or may be connectable to a pipe or tubing for guiding the shock wave into the boiler. Thereby the shock wave may be created in the system provided outside the boiler and efficiently transported into the boiler for cleaning.

The electrical means may comprise a capacitor for generating the discharge pulse. Thereby a sufficiently high energy may be transmitted through the wire for discharge.

The system may comprise a wire feeding arrangement configured to feed electrically conducting wire into the shock wave chamber to replace the wire after a discharge. Thereby the system may be regenerated in a simple manner after discharge of the wire.

The wire feeding arrangement may be connected to the electrical means for generating an electrical discharge pulse through the wire. Thereby an electrical contact means for the wire is achieved.

The system may comprise electrical contact means in the shock wave chamber, and wherein the wire feeding arrangement may be configured to feed wire towards the electrical contact means and to detect that the wire is in electrical contact with the electrical contact means for discharge. Thereby an automatic or semi-automatic wire feeding and wire regeneration system may be achieved. Further to this, the arrangement may be configured to diagnose the electrical connection of the wire.

The wire may be a metal wire having dimensions in the range of 0.1-0.9 mm, preferably in the range of 0.15-0.5 mm. Thereby a suitable range of wire dimensions for discharge is achieved.

The system may be in the form of a movable unit for convenient transportation to and from a boiler, preferably comprising a set of wheels.

The system may comprise a purge-air system configured to provide a controllable atmosphere in the housing, preferably comprising a pumping means for pumping air into the housing. Thereby any gases generated during discharge may be transported from the system. Also the system may be provided with an inert or controlled atmosphere in the shock wave chamber.

The invention further relates to a method for cleaning a boiler comprising the steps of

connecting a system as disclosed herein to the boiler,

providing an electrical current through the electrically conducting wire, to discharge the wire in order to generate a shock wave,

guiding the shock wave into the boiler for cleaning of dust deposit from surfaces in the boiler.

A shock wave may be defined as a pressure wave having a steep pressure increase. The pressure increase may be within a period of less than 10 μs, or 1 μs.

The method may further comprise feeding electrically conducting wire into the shock wave chamber for discharge.

The method may further comprise detecting that the electrically conducting wire is in electrical contact for discharge.

The boiler may be a water-tube boiler or a fire-tube boiler.

The shock wave may be guided into the boiler by means of a pipe or tubing connected to the boiler.

### BRIEF DESCRIPTION OF DRAWINGS

The invention is now described, by way of example, with reference to the accompanying drawings, in which:

FIG. 1 shows a schematic view of a system for cleaning of dust deposit from surfaces in the boiler.

FIG. 2 shows a perspective view of a system for cleaning of dust deposit from surfaces in the boiler.

FIG. 3 shows a perspective view of the system with doors removed.

FIG. 4 shows a wire feeding arrangement for the system.

### DESCRIPTION OF EMBODIMENTS

In the following, a detailed description of various embodiments of the system and method under the claims are disclosed.

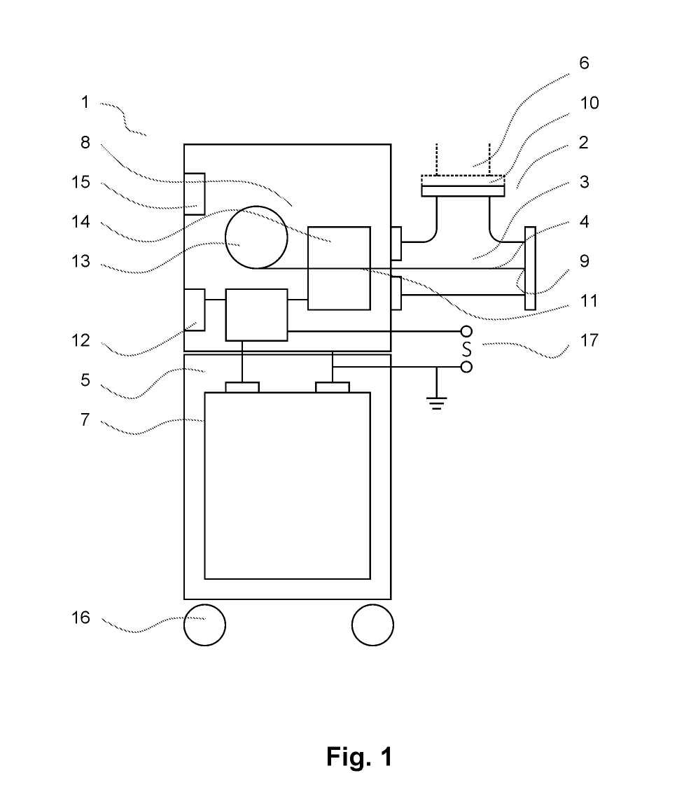

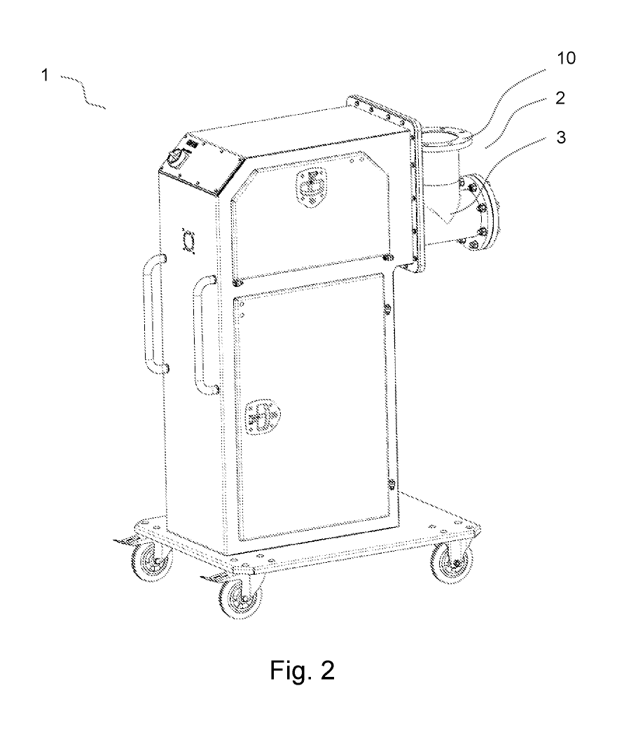

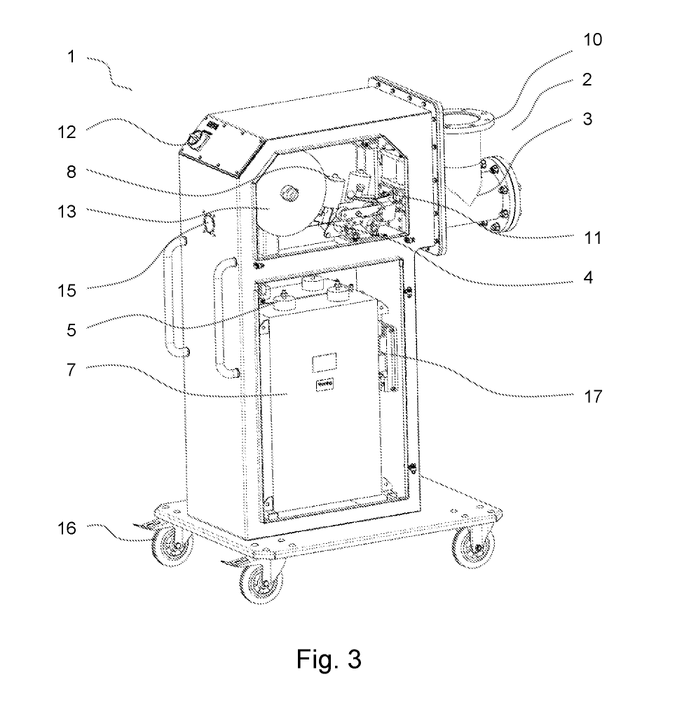

In FIG. 1 a schematic view of a system 1 for cleaning of dust deposit from surfaces in the boiler is shown. FIGS. 2 and 3 show two perspective views of a system 1 for cleaning of dust deposit from surfaces in the boiler, one with open doors and one with doors closed for operation. Similar features are given the corresponding reference numerals in the various figures.

The boiler may be a water-tube boiler wherein water circulates in tubes heated by hot gas from a furnace. In these types of boilers dust (soot etc.) is deposited on the outside of the tubes. Alternatively the boiler may be a fire-tube boiler wherein water circulates around tubes conducting hot gas from a furnace. In these types of boilers dust is deposited on the inside of the tubes conducting the hot gas.

The cleaning system comprises a housing 2 which is connectable to a pipe 6 leading into the boiler, by means of a pipe flange 10. The housing defines a shock wave chamber 3 formed by a T-shaped portion of the pipe. The housing is configured such that the shock wave chamber is connectable to the boiler.

Within the shock wave chamber an electrically conducting wire 4 is provided, extending from one side of the chamber to the other. The wire is of a electrically conducting metallic material and has a diameter of e.g. 0.15 mm, 0.20 mm, 0.30 mm, 0.40 mm or 0.50 mm. At one end portion, the wire is brought in contact with a first electrical contact means 9. At another portion the wire is in contact with a second electrical contact means 11, such that the wire may be subjected to an electrical current applied to a portion of the wire between the first and second electrical contact means. The first and second electrical contact means are connected to an electrical means 5 for generating an electrical discharge pulse through the wire. The electrical means comprises two capacitors 7 (250 μF, 10 kV) which are connectable to the electric wire through controllable electric switching means.

The electric switching means comprises a manually controlled electrical switch 12 for the operation of the system.

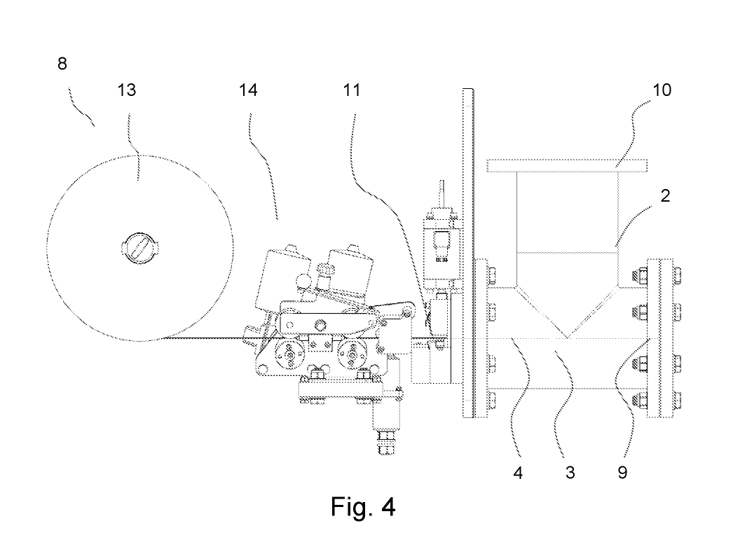

The system comprises a wire feeding arrangement 8 configured to feed electrically conducting wire into the shock wave chamber to replace the wire after a discharge. The wire feeding arrangement is further shown in FIG. 4. The wire feeding arrangement comprises a roll 13 of wire and a wire drive system 14 with at least one wire drive roll. The wire feeding arrangement comprises the second electrical contact means 11 and is thereby connected to the electrical means 5 for generating an electrical discharge pulse through the wire.

The wire feeding arrangement is further configured to feed wire towards the first electrical contact means 9 arranged in the shock wave chamber. When it is detected that the wire is in electrical contact with the electrical contact means for discharge, wire feeding is interrupted. This may simply be detected as the closing of an electric circuit. Thereby the regeneration of the wire in the shock wave chamber may be automatic or semi-automatic, and the system may comprise a diagnostic function to ensure that the wire is connected for discharge.

A purge-air system comprising a pumping means 15 is configured to provide a controllable atmosphere in the housing. The pumping means is in the form of a fan for pumping air into the housing. Thereby gases generated during operation of the device may be pumped by the purge-air system and transported into the boiler. Thus the any leakage of gases to the ambient surrounding of the system, may be minimized.

The system is provided with a set of wheels 16 in order to be provided as a movable unit for convenient transportation to and from a boiler. Further to this, the housing of the system is provided with handles for easy maneuvering of the wheeled assembly.

During operation of the system, the capacitors are charged with an energy of up to 1.25*10⁴ J. The system is connectable to mains power 17 for charging the capacitors. The energy is released through the portion of the wire between the first and second electrical contact means. Thereby the wire is rapidly heated by the resistance in the wire material and evaporated. A plasma is created whereby the electrical current is conducted between the first and second electrical contact means through the plasma. As an effect of the evaporation and ignition of a plasma in the shock wave chamber, a shock wave is generated. The shock wave is guided through the pipe 6 connected to the boiler and into the boiler for cleaning of dust deposit from surfaces in the boiler.

1. A system (1) connectable to a boiler, the system comprising a housing (2) connectable to the boiler defining a shock wave chamber (3), an electrically conducting wire (4) provided in the shock wave chamber, and electrical means (5) for generating an electrical discharge pulse through the wire such that to evaporate the wire and generate a shock wave for cleaning of dust deposit from surfaces in the boiler.

2. The system according to claim 1 wherein the system comprises or is connectable to a pipe (6) for guiding the shock wave into the boiler.

3. The system according to claim 1 or 2 wherein the electrical means comprises a capacitor (7) for generating the discharge pulse.

4. The system according to any one of the preceding claims comprising a wire feeding arrangement (8) configured to feed electrically conducting wire into the shock wave chamber to replace the wire after a discharge.

5. The system according to claim 4 wherein the wire feeding arrangement is connected to the electrical means (5) for generating an electrical discharge pulse through the wire.

6. The system according to claim 4 or 5 wherein the system comprises electrical contact means (9) in the shock wave chamber, and wherein the wire feeding arrangement is configured to feed wire towards the electrical contact means and to detect that the wire is in electrical contact with the electrical contact means for discharge.

7. The system according to any one of the preceding claims wherein the wire is a metal wire having dimensions in the range of 0.1-0.9 mm, preferably in the range of 0.15-0.5 mm.

8. The system according to any one of the preceding claims in the form of a movable unit for convenient transportation to and from a boiler, preferably comprising a set of wheels.

9. The system according to any one of the preceding claims further comprising a purge-air system configured to provide a controllable atmosphere in the housing, preferably comprising a pumping means for pumping air into the housing.

10. A method for cleaning a boiler comprising the steps of
connecting a system according to any one of claims 1 to 9 to the boiler,
providing an electrical current through the electrically conducting wire, to discharge the wire in order to generate a shock wave,
guiding the shock wave into the boiler for cleaning of dust deposit from surfaces in the boiler.

11. The method according to claim 10 comprising feeding electrically conducting wire into the shock wave chamber for discharge.

12. The method according to claim 11 comprising detecting that the electrically conducting wire is in electrical contact for discharge.

13. The method according to any one of claims 10 to 12 wherein the boiler is a water-tube boiler.

14. The method according to any one of claims 10 to 13 wherein the boiler is a fire-tube boiler.
